(19) United States
(12) Patent Application Publication
(10) Pub. No.: US 2014/0109974 A1
(43) Pub. Date: Apr. 24, 2014

(54) Vehicle having a plurality of storage vessels for a combustible gas, and method for displaying the available stored quantity and controlling the extraction

(71) Applicant: Henning Zoz, Freudenberg (DE)

(72) Inventor: Henning Zoz, Freudenberg (DE)

(73) Assignee: ZOZ GMBH, Wenden (DE)

(21) Appl. No.: 14/124,063

(22) PCT Filed: Jun. 5, 2012
(86) PCT No.: PCT/EP2012/002385

§ 371 Date: Dec. 5, 2013

(30) Foreign Application Priority Data
Jun. 6, 2011 (DE) 10 2011 104 711.9

(51) Int. Cl. F17C 13/02

(52) U.S. Cl. CPC F17C 13/02
USPC 137/1; 137/351

(57) ABSTRACT

The present invention relates to a vehicle (2) having a drive (4) for a combustible gas, in particular hydrogen, and a plurality of storage vessels (6) for a combustible gas which are connected to the gas drive (4) via a connector. In order to provide a simple possibility of determining at least approximately accurately the still present residual quantity of a combustible gas which is available for the operation of the vehicle, it is proposed that a plurality of storage vessels (6) are connected to the vehicle (2), wherein each storage vessel (6) has a connection piece (8), by way of which it can be connected to the vehicle-side connector (10) mechanically and in a pressure-resistant manner, and the vehicle (2) has an electronic controller (16), by which the number of storage vessels (6) which are connected to the vehicle (2) and the presence of combustible gas in the respective storage vessels (6) can be determined via sensors, and the electronic controller (16) transmits a quantity signal about the gas quantity which is still available from the storage vessels (6) to a supply display (18) which is present in the vehicle (2), wherein the magnitude of the quantity signal is dependent on the number of storage vessels (6) which have been detected as being connected to the vehicle (2) and filled.

The present invention concerns a vehicle with a drive for a combustible gas, in particular hydrogen, and several storage containers for a combustible gas that are connected by a connecting socket with the gas drive as well as a method for displaying the available stored quantity of a combustible gas and for controlling removal of the combustible gas from a plurality of storage containers, present in a vehicle provided with a gas drive, with an electronic control unit.

From the publication DE 11 2006 000 829 T5 it is known to furnish a fuel-cell operated vehicle, which can be operated with hydrogen as a combustible gas, with a fuel tank. The hydrogen is stored in the tank in gaseous state. For hydrogen tanks it is however difficult to reliably determine the still available fill quantity of hydrogen gas in the tank. In other gas tanks, the still available fill quantity can also be determined only with increased expenditure.

It is therefore an object of the present invention to provide a simple possibility for precisely determining, at least approximately, the still available residual quantity of a combustible gas that is available for operation of the vehicle.

The object is solved for a device of the aforementioned kind in that several storage containers are connected with the vehicle, wherein each storage container has a connecting member with which it can be connected mechanically and pressure-resistant to the connecting socket at the vehicle, and the vehicle has an electronic control unit by means of which, by sensors, the number of storage containers connected with the vehicle as well as the presence of a combustible gas in the respective storage containers can be determined, and the electronic control unit transmits a quantity signal of the still available gas quantity contained in the storage containers to a stored quantity display device present within the vehicle, wherein the magnitude of the quantity signal depends on the number of storage containers that are connected to the vehicle and are recognized as filled.

For three or more storage containers, it is possible to provide a stored quantity display device which in particular is based on the number of existing storage containers and already has a meaningful utilizable resolution. For example, when three full storage containers are present, the stored quantity display can indicate “full”. When one of the three storage containers is completely empty, the two remaining still full storage containers are sufficient to indicate a still available contents of two thirds. When also a second storage container is completely empty, an available residual quantity of only one third can be indicated. When the third storage container is also empty, the stored quantity display indicates an empty supply. The possibility of being able to first use up two storage containers completely before the last container is utilized, improves the prognosis reliability in this time period considerably. The more storage containers are employed, the stored quantity display that is based on the number of existing storage containers can all the more precisely indicate the available residual quantity. For example, for ten storage containers, the stored quantity can be displayed in steps of one tenth. With this stored quantity display that is based on the number of existing storage containers, complex, imprecise, failure-prone, and expensive measuring technologies are obsolete. The measuring technology according to the invention is sufficiently precise, inexpensive, and less prone to failure.

Dividing the fuel supply of a combustible gas for vehicles into a plurality of storage containers provides the additional advantage of easier refill of the fuel. The fuel supply can be refilled by a simple and fast exchange of the empty storage containers that are present within the vehicle for full new storage containers. The smaller storage containers can be handled easily, they can be easily installed in and removed from a vehicle, and the available space can be utilized better with smaller exchangeable storage containers in comparison to fewer larger storage containers. The distribution of a fuel supply onto several smaller containers has also safety advantages because when one storage container is damaged only a small quantity of the combustible gas will reach the atmosphere and the resulting explosion risk and fire risk are accordingly reduced.

An individual storage container cannot be filled at a fueling station with combustible gas at just any rate, in particular when the combustible gas is hydrogen that is to be filled into a solid-state storage device, for example, a metal hydride storage device or a storage device with a material with organometallic frame structures.

The solid-state storage devices are attractive for combustible gases in mobile applications because they require no special thermal insulation as do, for example, liquid gas containers, and have significantly lower gas loss rates than high-pressure containers.

Because of the comparatively slow release of the combustible gas, in particular of hydrogen, the solid-state storage devices in case of accidents or leaks also have a lower explosion risk than other container forms.

In order to reduce diffusion of combustible gas, in particular hydrogen, from the storage container over the length of storage, the solid-state storage devices are filled with a solid-state material on which the atoms of the combustible gas adsorb. The adsorption of the atoms on the solid-state material requires however time so that the refueling processes would be extended to an unacceptable level. In case of a fast refueling of a solid-state storage device, the solid-state material will also heat up very quickly and strongly so that the energy expenditure and the costs for refueling increase and the economic viability is thereby lowered. In case of an exchange of storage containers as a refueling process, the empty storage containers can be subsequently slowly refilled with a combustible gas without the driver of the vehicle having to wait for this. The filling process following the container exchange of the empty storage containers can be subsequently carried out energy-efficiently at lower filling rates at reduced costs.

The filling process of the exchanged empty storage containers moreover can be realized in an automated fashion so that personnel-related expenditure for refilling of the empty storage containers can be limited to a minimum. A refueling station can be in the form of an automated machine that accepts standardized empty storage containers, dispenses full storage containers, and refills the accepted empty storage containers with a combustible gas as they pass through a storage device so that, after completion of the filling process, they can again be dispensed as filled storage containers to the customers.

By means of a plurality of storage containers, partial filling processes can be realized also quickly and simply. For example, when five storage containers of which three are empty are existing in the vehicle, these three can be quickly and easily exchanged in order to furnish the vehicle again with a maximum possible fuel supply, or, only one or two of the three empty storage containers are exchanged.

Since the electronic control unit is capable of recognizing which one of the storage containers is empty, partially filled, or full, the desired display of the still existing fuel supply is sufficiently precise. The recognition is realized by means of sensors. In this way it is possible to determine by sensors if storage containers are connected at all and how many are connected to the existing connecting sockets. In this way, a determination of the total number of connected storage containers is possible. In addition, sensors are provided with which it can be determined whether a combustible gas is exiting at all from the individual storage containers. This can be realized, for example, by means of a gas flow control by testing individual storage containers by individually connecting them. The filling level of a storage container can however also be manually entered in a technically simple manner upon exchange of the storage container by means of an operating button or, upon insertion of a new storage container, a switching signal is triggered by means of which a newly inserted storage container is recognized as “full”. Therefore, for the purpose of the invention, it must not always be precisely measured whether actually the combustible gas is still contained in a storage container but the filling level can be simulated also by assumption or manual input.

A “filled” recognition of a storage container by means of the electronic control unit does not mean mandatorily that the storage container in question must be always completely filled, a “filled” recognition can also mean a partial filling. The more storage containers are however used in a vehicle as a fuel supply, the lower the error proportion effecting the display of the total supply as a result of an erroneous “full” declaration of a storage container.

When the electronic control unit has already recognized for a storage container during operation that no combustible gas flows any longer out of this storage container and for this reason switching to another storage container must be carried out in order to maintain the supply of fuel, the electronic control unit can assume that the storage container in question is “empty” until it is exchanged. The storage container, which has been recognized as “empty” in this way can be taken into account when displaying the remaining supply of fuel.

A prerequisite for displaying a supply that is based on the number of existing storage containers and the full/empty differentiation is that the storage containers at least substantially are emptied sequentially and not in parallel. In this context, in the electronic control unit software is provided with which one of the existing storage containers is selected from which the combustible gas is supplied to the gas drive and the combustible gas is removed exclusively, or at least primarily, from this single selected storage container until this selected storage container is completely empty.

The quantity signal can be output by the electronic control as an absolute or relative value and/or it can relate to the gas volume, gas weight, the calorific value in KWh and/or the available remaining travel range of the vehicle, for example. The stored quantity display can be realized by means of a color and/or contrasting characterization of bars or light points whose number corresponds to the number of existing connecting possibilities of storage containers.

According to one embodiment of the invention, the magnitude of the quantity signal depends additionally on the operating data of the storage containers detected by the control unit. For example, it is possible to determine computationally in the electronic control unit by means of a suitable software the approximate fuel consumption of the gas drive based on the performance data of the drive, the operating parameters, the demanded power output, the operating times, and the like. When the approximated fuel consumption that has been determined in this way is then subtracted from the nominal contents of a full storage container, the residual quantity of fuel that remains approximately within the respective storage container is obtained. Instead of displaying for a partially emptied storage container still a complete fill, the computationally determined approximate residual quantity for this storage container can be taken into account for the magnitude of the quantity signal. When one of three storage containers is empty, one is half full, and one is completely full, instead of a two third full signal a half full signal can be displayed based on the computational determination of the probable consumption.

According to one embodiment of the invention, each storage container has an electronic memory device in which container-relevant, filling level-relevant, filling medium-relevant and/or other data are stored so as to be retrievable by a communication interface, the electronic control unit is connected by means of a communication link with each electronic memory device of the storage containers by means of the communication interface for data exchange, and the magnitude of the quantity signal is additionally dependent on the data retrieved from the electronic memory devices. As a container-relevant datum, for example, the first operation, the number of charge cycles, the date of last filling, the owner, information in regard to the employed solid-state material and the removal rates of combustible gas that are enabled with it, a service date, or the service history can be stored. Filling level-relevant data can relate to the actual filling level that has been saved either after the last filling or after a partial use. Filling medium-relevant data can relate to the filling medium itself, respectively, the fuel that is stored in the storage container, for example the type and composition of the stored gas, pressure values, temperature values and the like. By retrieval of these data by means of the electronic control unit, the latter can compute more precisely still existing filling levels and travel ranges of the still existing fuel.

According to one embodiment of the invention, the electronic control unit can actuate valves with which a conduit connection between a storage container and the gas drive can be opened and/or closed and the electronic control unit is programmed such that the valves are switched in such a way that the combustible gas is first removed from an already partially emptied storage container until the latter is completely empty before combustible gas is removed from a still full storage container. In this way, it is ensured that the storage containers are not emptied, if possible, simultaneously but sequentially so that the electronic control unit can assume rightfully that the full storage containers indeed are still full and storage containers that have been recognized as empty are actually empty, and imprecisions in connection with estimation of the remaining supply are caused as much as possible only by the imprecisions in regard to estimating the residual quantity in a partially emptied storage container. The error rate of the display can be kept at a minimum by this method.

According to one embodiment of the invention, the electronic control unit has within the software a special operating mode in which the valves are switched such that a combustible gas can be removed parallel from more than one storage container. As a special operating mode, an operating mode is conceivable, for example, in which from the gas drive a higher power output is demanded than can be generated with the gas supply from only a single storage container, or the gas flow from an almost empty storage container decreases more and more so that a new storage container must provide an additional supply in order to ensure a sufficient gas supply of the gas drive.

According to one embodiment of the invention, on the connecting socket and/or the connecting member a filling level indicator for the corresponding storage container is present that is controllable by the electronic control unit as a function of the data that are available in the electronic control unit. The filling level indicator signals to the user of the vehicle which ones of the storage containers must be exchanged in exchange for new full storage containers. The unnecessary exchange of still full or partially full storage containers is thus avoided.

According to one embodiment of the invention, the connecting socket and the connecting member are formed as quick exchange coupling. In this way, the exchange of storage containers is facilitated. By standardized connections it is possible to purchase and exchange storage containers everywhere.

According to one embodiment of the invention, in the electronic control unit each of the connecting sockets has assigned an individual identification and the electronic control unit computes, under this individual identification, for a storage container that is connected to the corresponding connecting socket, based on container-relevant, filling level-relevant and/or filling medium-relevant data that are retrieved from the electronic memory device together with consumption-specific and operation-specific data of the gas drive, in predetermined time intervals new filling level data of this storage container and takes them into account for the calculation of the quantity signal and/or transmits the new filling level data to the electronic memory device of the storage container connected under the individual identification.

According to one embodiment of the invention, the storage containers are solid-state storage devices. Solid-state storage devices are particularly suitable for use in the vehicles because they have a sufficient storage capacity, excellent operating safety, minimal storage losses, and comparatively minimal costs.

The object for the method according to the invention is solved in that the electronic control unit determines the number of existing storage containers, reads out container-relevant, filling level-relevant and/or filling medium-relevant data from the electronic memory device correlated with a respective storage containers and/or from its own memory, computes the data to a value for an available supply quantity, derives therefrom a quantity signal that is transmitted to a display device that is present within the vehicle and with the electronic control unit valves can be operated with which a conduit connection between a storage container in the gas drive is opened and/or closed, wherein upon consumption of combustible gas from the storage containers the electronic control unit opens primarily a valve to an already partially emptied storage container until it is completely emptied before combustible gas is removed from a still full storage container.

According to one embodiment of the invention, in a special operating mode gas can be removed from more than one storage container by an appropriate switching of the valves.

It is expressly noted that the afore described embodiments of the invention taken individually as well as in any suitable combination with other embodiments of the invention can be combined with the subject matter of the independent claim inasmuch as nothing to the contrary can be taken from this specification and the claims.

Further embodiments and variants of the invention can be taken from the following representational description.

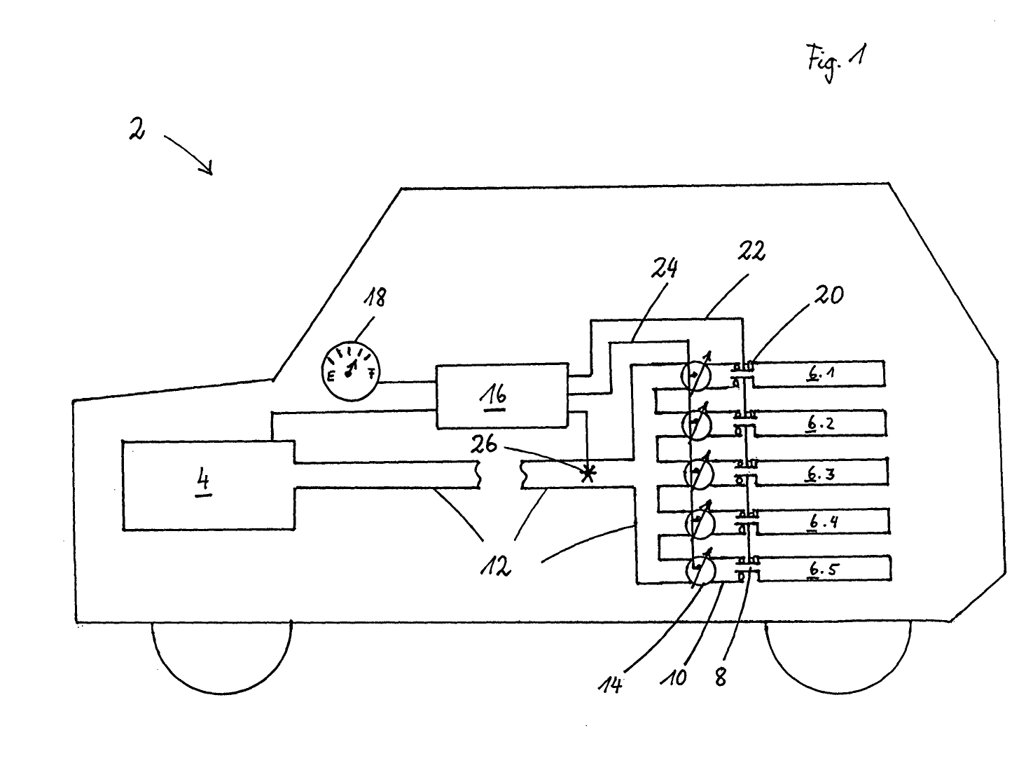

In FIG. 1 a vehicle 2 is indicated in an exemplary form by the contour of a side view of an automobile. The vehicle 2 can also be a motorcycle, truck or any other vehicle. The vehicle 2 has a gas drive 4 which is comprised, for example, of one or several fuel cells, one or several batteries for storage of electric power that is generated by the fuel cells, and one or several electric motors.

In the illustrated embodiment, a total of five storage containers 6.1-6.5 in which combustible gas, in particular hydrogen, is stored are connected with the vehicle 2. Of course, in the vehicle 2 more or fewer storage containers 6 can be present or provided also; for this purpose, the vehicle 2 then comprises a corresponding number of connecting sockets 10. Each storage container 6 has a connecting member 8 which is connected to the respective connecting socket 10 at the vehicle. The connection of the respective connecting member 8 with the corresponding connecting socket 10 is pressure-resistant, gas-tight, and can be easily disconnected and reconnected by a quick coupling, not illustrated in more detail in the drawing.

Each connecting socket 10 is connected to a conduit 12 by means of which the combustible gas which is exiting from the storage container 6 is guided to the gas drive 4. The free gas flow is interrupted by valves 14 that are correlated with each individual connecting socket 10. The valves 14 are actuatable by the electronic control unit 16. The control unit 16 transmits a quantity signal to the stored quantity display device 18 in the vehicle 2 based on which the driver of the vehicle 2 can recognize how much fuel is still stored within the storage containers 6.

In the embodiment, each storage container 6 has a memory device 20 which in the mounted position of the storage container 6 is connected by means of connecting cable 22 with the control unit 16. The connection of the memory device 20 with the connecting cable 22 and thus with the control unit 16 can however also be achieved by a sliding contact, not illustrated in detail, or a plug that is mandatorily contacted by means of suitable shaping when the storage container 6 is plugged into the connecting socket 10. By means of the connecting cable 22 data exchange between the memory device 20 and the control unit 16 is possible.

The control unit 16 is connected with the valves 14 by means of a further connecting cable 24 through which control commands from the control unit 16 are transmitted to the valves 14. In case of intelligent valves 14, it is also possible that they transmit information back to the control unit 16. By means of the control commands transmitted through the connecting cable 24, the individual valves 16 can be opened and closed depending on the predetermination by the control unit 16. In FIG. 1 all of the valves 14 are shown in a closed position. Depending on the control directive of the control unit 16, the valves 14 can be opened individually, several of them, or all of them together in order to allow a combustible gas to flow from the storage containers 6 into the conduit 12.

As an example of a sensor, in FIG. 1 a measuring wheel 26 is indicated in the conduit 12 with which a gas flow in the conduit 12 can be determined. By means of the measuring wheel 26, it can be determined after opening one of the valves 14 whether a gas is flowing out of the respective storage container 6 correlated with the opened valve. When accordingly a rotary speed of the measuring wheel 26 is missing, the control unit 16 can derive from this that from the opened storage container 6 no gas flow is exiting and that the corresponding storage container 6 is empty. Subsequently, the control unit 16 can close the corresponding valve 14 and test the next storage container 6 until all storage containers 6.1-6.5 have been tested. For each of the storage containers 6.1-6.5, the control unit 16 can save the respective test result, namely in its own memory as well as in the memory device 20 of the corresponding storage container 6.

The control unit 16 can also exchange data with the gas drive 4 through a cable connection. In this context, the data can be consumption data and/or performance data of the drive based on which it is possible to deduce the removal quantity of the combustible gas from one or several storage containers 6. Based on the evaluation of these data, the electronic control unit 6 is capable of calculating also partial removal quantities which have been removed from a storage container 6. Partial removal quantities can be derived also from the sensor signal of the measuring wheel 26, for example. The thus determined partial removal quantity can be subtracted from the theoretically present nominal gas volume within the corresponding storage container 6 so that in this way also storage quantities than the integer of storage containers can be utilized for the stored quantity display.

In deviation from the embodiment, the data transmission, control commands, and sensor queries not only can be done by several cables but also by a single bus cable and/or by radio modules and/or by fiber optics or other suitable known transmission means for electronic communication.

The above representational description of the invention serves for illustration purposes only. The invention is not at all to be limited to the afore described embodiment. A person of skill in the art will have no problem in adjusting the features of the invention in a way that he considers suitable for a concrete application situation.

What is claimed is:

1.-11. (canceled)

12. A vehicle comprising:
a drive operating with a combustible gas;
connecting sockets communicating with the drive;
storage containers for storing the combustible gas;
the storage containers each having a connecting member with which the storage containers are connectable mechanically and pressure-resistant to one of the connecting sockets, respectively,
an electronic control unit;
sensors connected to the electronic control unit and adapted to determine how many storage containers are connected to the connecting sockets and to detect the presence of the combustible gas in the storage containers;
a stored quantity display device connected to the electronic control unit, wherein the electronic control unit transmits a quantity signal of a gas quantity that is still available from the storage containers to the stored quantity display device;
wherein a magnitude of the quantity signal depends on how many storage containers have been recognized as connected with the connecting sockets and have been recognized as filled.

13. The vehicle according to claim 12, wherein the magnitude of the quantity signal depends additionally on operating data of the storage containers determined by the control unit.

14. The vehicle according to claim 12, wherein the storage containers each comprise an electronic memory device in which data are stored, including container-relevant data, filling level-relevant data, and filling medium-relevant data, wherein the data are retrievable via a communication interface from the electronic memory device, wherein the electronic control unit is connected for data exchange by a communication link to each one of electronic memory devices via the communication interface, and wherein the magnitude of the quantity signal additionally depends on the data retrieved from the electronic memory devices.

15. The vehicle according to claim 12, comprising conduit connections connecting the storage containers to the drive and further comprising valves disposed in the conduit connections, wherein the valves are actuatable by the electronic control unit to open or close the conduit connections, wherein the electronic control unit is programmed to switch the valves such that the combustible gas is first removed from an already partially emptied storage container until the partially emptied container is completely emptied before the combustible gas is removed from one of the storage containers that is full.

16. The vehicle according to claim 15, wherein the electronic control unit is programmed with a special operating mode in which the valves are switched such that the combustible gas is removed parallel from several of the storage containers.

17. The vehicle according to claim 12, further comprising filling level indicators disposed on the connecting sockets, wherein the filling level indicators are controlled by the electronic control unit as a function of the data available in the electronic control unit.

18. The vehicle according to claim 12, further comprising filling level indicators disposed on the connecting members of the storage containers, wherein the filling level indicators are controlled by the electronic control unit as a function of the data available in the electronic control unit.

19. The vehicle according claim 12, wherein the connecting sockets and the connecting members are formed so as to interact with each as a quick exchange coupling.

20. The vehicle according to claim 12, wherein the connecting sockets each have an assigned individual identification assigned thereto in the electronic control unit, wherein the electronic control unit computes for a connected storage container connected to one of the connecting sockets, under the assigned individual identification for the storage container, in predetermined time intervals new filling level data of the connected storage container based on container-relevant, filling level-relevant and/or filling medium-relevant data retrieved from the electronic memory device of the connected storage container and further based on consumption-specific and operation-specific data of the drive, wherein the electronic control unit takes into account the new filling level data in calculating the quantity signal and/or transmits the new filling level data to the electronic memory device of the connected storage container.

21. The vehicle according to claim 12, wherein the storage containers are solid-state storage devices.

22. A method for displaying an available stored quantity of a combustible gas and for controlling removal of the combustible gas from a plurality of storage containers present within a vehicle provided with a gas drive, the method comprising:
providing an electronic control unit adapted to actuate valves in conduit connections between the storage containers and the gas drive for opening and closing the valves;
determining with the electronic control unit how many storage containers are present in the vehicle;
reading out container-relevant, filling level-relevant and/or filling medium-relevant data from electronic memory devices that are associated the storage containers and/or from a memory of the electronic control unit;
computing the data to a value for an available stored quantity;
deriving from the computed stored quantity a quantity signal and transmitting the quantity signal to a stored quantity display device of the vehicle;
upon consumption of combustible gas from the storage containers, opening a valve with the electronic control unit primarily to a storage container that is already partially emptied until the partially emptied container is completely emptied before combustible gas is removed from one of the storage containers that is full.

23. The method according to claim 22, further comprising, in a special operating mode, removing combustible gas from more than one storage container by appropriately switching the valves.
